(19) United States
(12) Patent Application Publication
(10) Pub. No.: US 2016/0079658 A1
(43) Pub. Date: Mar. 17, 2016

(54) Wireless Communication Antenna Module and Portable Terminal Comprising Same

(71) Applicant: AMOTECH CO., LTD., Incheon (KR)

(72) Inventors: Eul-Young Jung, Incheon (KR); Hyung-Il Baek, Gyeonggi-do (KR); Beom-Jin Kim, Gyeonggi-do (KR); Chi-Ho Lee, Incheon (KR); Do-Hyung Lee, Incheon (KR)

(73) Assignee: AMOTECH CO., LTD., Incheon (KR)

(21) Appl. No.: 14/768,166

(22) PCT Filed: Feb. 14, 2014
(86) PCT No.: PCT/KR2014/001233

§ 371 Date: Nov. 20, 2015

(30) Foreign Application Priority Data
Feb. 14, 2013 (KR) 10-2013-0015842
Feb. 14, 2014 (KR) 10-2014-0017221

(51) Int. Cl. H01Q 1/24

(52) U.S. Cl. CPC H01Q 1/243

(57) ABSTRACT

Disclosed are a wireless communication antenna module and a portable terminal including the same for maximizing the performance of an antenna by mounting a radiation sheet so as to partially overlap with an antenna sheet. The disclosed wireless communication antenna module comprises: the antenna sheet provided with a radiation pattern and is installed on a portable terminal main body or a battery pack; and the radiation sheet installed on a rear-surface housing of the portable terminal, wherein an overlapping area is formed by laminating the antenna sheet and the radiation sheet in an overlapping manner when the portable terminal main body and the radiation sheet are coupled.

### TECHNICAL FIELD

The present invention generally relates to a wireless communication antenna module. More particularly, the present invention relates to a wireless communication antenna module that is installed in a portable terminal and communicates with a wireless communication antenna module of another portable terminal, and a portable terminal having the wireless communication antenna module.

The present application claims the benefit of Korean Patent Application No. 10-2013-0015842, filed on Feb. 14, 2013, Korean Patent Application No. 10-2014-0017221, field on Feb. 14, 2014, the contents of which are entirely incorporated herein by reference.

### BACKGROUND ART

With technological development, portable terminals such as a mobile phone, a PDA, and PMP, a navigation system, and a laptop additionally provides DMB, wireless internet, and a near field communication function of devices, in addition to basic functions such as calling, playing video/music, and navigation. Accordingly, portable terminals have a plurality of antennas for wireless communication such as wireless internet and Bluetooth.

Further, recently, functions such as information exchange between terminals, payment, ticket advance purchase, and searching using near field communication (NFC) are applied to portable terminals. To this end, these portable terminals are equipped with an antenna module for portable terminals (that is, near field communication antenna module) used in a near field communication type. The wireless communication antenna module is a non-contact local wireless communication module, which is an RFID using a frequency band of about 13.56 Hz, and transmits data between terminals at a short distance of about 10 cm. A wireless communication antenna module is used in various areas such as transmission of product information at a supermarket or a store or transmission of travel information of visitors, traffic, access control, and a locking system, in addition to payment.

Recently, the market of portable terminals such as a tablet PC or a smartphone has rapidly increased. Portable terminals recently include functions such as information exchange between terminals, payment, advance ticket purchase, and searching using local communication (that is, NFC). Accordingly, there is an increased demand for a wireless communication antenna module that is used for near field communication. In relation to a wireless communication antenna module, there are Korean Patent Application Publication No. 10-2009-0126323 (titled, “NFC module, particularly for mobile telephone”) and Korean Patent No. 10-1098263 (titled, “NFC loop antenna).

A differential antenna type of wireless communication antenna module is usually used for portable terminals. The differential antenna type of wireless communication antenna module receives signals from an external terminal through a radiator pattern, in which the signals are transmitted only through a signal line connected to one end of the radiator pattern. Accordingly, the intensity of a received signal is low in the wireless communication antenna modules of the related art, so the reception performance is decreased and the reader mode recognition distance is reduced.

### DISCLOSURE

### Technical Problem

Accordingly, the present invention has been made keeping in mind the above problems occurring in the prior art, and an object of the present invention is to provide a wireless communication antenna module that maximizes antenna performance by mounting a radiator sheet over a portion of an antenna sheet, and a portable terminal having the wireless communication antenna module.

### Technical Solution

In order to accomplish the above object, the present invention provides a wireless communication antenna module that includes: an antenna sheet having a radiation pattern thereon and mounted on a portable terminal body or a battery pack; and a radiation sheet mounted on a rear housing of a portable terminal, in which when the portable terminal body and the rear housing are combined, the antenna sheet and the radiation sheet form an overlap area by overlapping each other.

The antenna sheet may have at least one bending portion and may be mounted on at least one surface of a front side, a rear side, and a side of the portable terminal or the battery pack by bending with respect to the at least one bending portion.

The radiation sheet may form an overlap area with a radiation pattern and a non-patterned portion formed on the antenna sheet mounted on the rear side of the portable terminal body or the battery pack.

The radiation sheet may have an opening at a side where the overlap area is formed.

The radiation sheet may form an overlap area with a radiation pattern, except for radiation patterns formed on both sides of a non-patterned portion, in the radiation pattern formed on the antenna sheet mounted on the rear side of the portable terminal body or the battery pack.

The antenna sheet may include: a first radiation pattern formed in a loop shape by winding a wire several times around an edge of a non-first patterned portion; and a second radiation pattern formed in a loop shape by winding a wire several times around an edge of a non-second patterned portion, and a first end of the first radiation pattern may be connected with a first end of the second radiation pattern.

The antenna sheet may include a radiation pattern formed in a loop shape winding a wire several times around edges of a non-first pattered portion and a non-second patterned portion, and the radiation pattern may form a cross area at an area mounted on a side of the portable terminal body or the battery pack.

In order to accomplish the above object, the present invention provides a wireless communication antenna module that includes: an antenna sheet having a radiation pattern thereon and mounted on a portable terminal body or a battery pack; and a rear housing having a metal area thereon and combined with the portable terminal body, in which when the portable terminal body and the rear housing are combined, the antenna sheet and the metal area of the rear housing form an overlap area by overlapping each other.

The antenna sheet may have at least one bending portion and may be mounted on one surface of a front side, a rear side, and a side of the portable terminal or the battery pack by bending with respect to the at least one bending portion.

The metal area of the rear housing may form an overlap area with a radiation pattern and a non-patterned portion formed on the antenna sheet mounted on the rear side of the portable terminal body or the battery pack.

The metal area of the rear housing may have an opening at a side where the overlap area is formed.

The metal area of the rear housing may form an overlap area with a radiation pattern, except for radiation patterns formed on both sides of a non-patterned portion, in the radiation pattern formed on the antenna sheet mounted on the rear side of the portable terminal body or the battery pack.

The antenna sheet may include: a first radiation patter formed in a loop shape by winding a wire several times around an edge of a non-first patterned portion; and a second radiation pattern formed in a loop shape by winding a wire several times around an edge of a non-second patterned portion, and a first end of the first radiation pattern may be connected with a first end of the second radiation pattern.

The antenna sheet may include a radiation pattern formed in a loop shape winding a wire several times around edges of a non-first patterned portion and a non-second patterned portion, and the radiation pattern may form a cross area at an area mounted on a side of the portable terminal body or the battery pack.

### Advantageous Effects

According to the present invention, since an overlap area is formed by overlapping a radiation pattern and a radiation sheet formed on an antenna sheet (or a rear housing of a portable terminal made of metal) in a wireless communication antenna module, the radiation area of a magnetic field is increased and the antenna characteristics are improved.

Further, since an overlap area is formed by overlapping a radiation pattern and a radiation sheet formed on an antenna sheet (or a rear housing of a portable terminal made of metal) in a wireless communication antenna module, a magnetic flux loop is increased by the radiation sheet (or the rear housing) and the antenna characteristics are improved.

### DESCRIPTION OF DRAWINGS

FIGS. 1 to 5 are diagrams illustrating a wireless communication antenna module according to a first embodiment of the present invention.

FIGS. 6 to 17 are diagrams illustrating a wireless communication antenna module according to a second embodiment of the present invention.

FIGS. 18 to 22 are diagrams illustrating a wireless communication antenna module according to a third embodiment of the present invention.

FIGS. 23 to 31 are diagrams illustrating antenna characteristics of a wireless communication antenna module according to an embodiment of the present invention.

### MODE FOR INVENTION

Exemplary embodiments of the present invention will be described below with reference to the accompanying drawings in order for those skilled in the art to be able to easily implement the technical spirit of the present invention. First, in the specification, in adding reference numerals to components throughout the drawings, it should be noted that like reference numerals designate like components even though components are shown in different drawings. In describing the present invention, well-known functions or constructions will not be described in detail since they may unnecessarily obscure the understanding of the present invention.

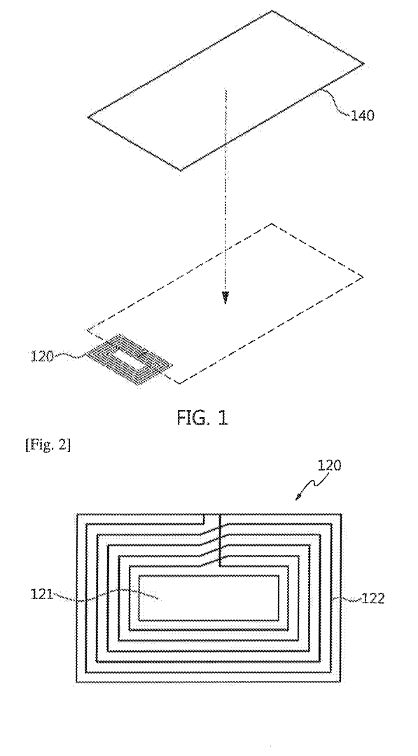

Hereafter, a wireless communication antenna module according to a first embodiment of the present invention is described in detail with reference to the accompanying drawings. FIGS. 1 to 5 are diagrams illustrating a wireless communication antenna module according to a first embodiment of the present invention. The wireless communication antenna module according to the embodiment of the present invention can be applied to near field communication such as Bluetooth and a wireless communication antenna module applied to an NFC band is exemplified.

As illustrated in FIG. 1, a wireless communication antenna module includes an antenna sheet 120 mounted on a portable terminal body (or a battery pack) and a radiation sheet 140 mounted on the rear side of the portable terminal and forming an overlap area by overlapping a portion of the antenna sheet 120 when the portable terminal body and a rear housing are combined.

The antenna sheet 120 has a first radiation pattern 122 that resonates at a wireless communication frequency band. The antenna sheet 120 has the first radiation pattern 122 on at least one of the top and the bottom. The antenna sheet 120 may be one sheet with a radiation pattern or may be formed by stacking a plurality of sheets having a radiation pattern. As shown in FIG. 2, the antenna sheet 120 has a non-first patterned portion 121 and the first radiation pattern 122 on at least one of the top and the bottom.

The non-first patterned portion 121 is defined in a predetermined area from the center of the antenna sheet 120 for ideal radiation of a magnetic field. Although the non-first patterned portion 121 is formed in the shape of a rectangle in FIG. 2, it is not limited thereto and may be formed in various shapes such as a circle and a polygon.

The first radiation pattern 122 is formed in the shape of a loop in which a wire is wound several times around the non-first pattered portion 121. The first radiation pattern 122 is wound by a predetermined number of times (number of turn: 1 or more turns) according to inductance that is set in accordance with characteristics of the wireless communication antenna module. Both ends of the first radiation pattern 122 are connected a power supply terminal (not shown) connected to a circuit of a portable terminal.

The radiation sheet 140 is made of metal and disposed inside a rear housing of a portable terminal to operate as a sub-radiator of the first radiation pattern 122 formed on the antenna sheet 120. The radiation sheet 140 may be formed in various shapes in accordance with the shape of the rear housing 240.

The radiation sheet 140 partially overlaps the antenna sheet 120 when a portable terminal body and the rear housing are combined. Accordingly, the radiation sheet 140 forms an overlap area by partially overlapping at a side the first radiation pattern 122 formed on the antenna sheet 120 and operates as a sub-radiator in the overlap area by magnetic-coupling with the first radiation pattern 122.

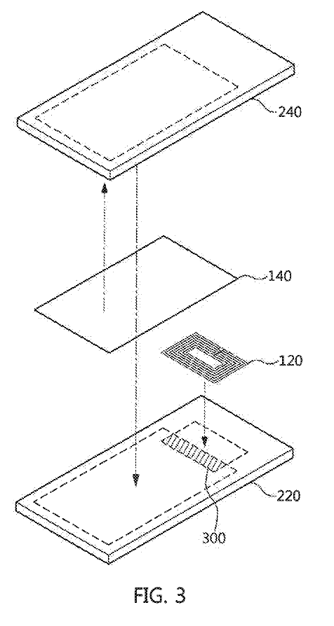

The coupling relationship between the antenna sheet 120 and the radiation sheet 140 is described hereafter, with reference to FIGS. 3 to 5.

As shown in FIG. 3, the antenna sheet 120 is disposed at the upper portion on the rear side of a portable terminal body 220 and the radiation sheet 140 is disposed in a rear housing 240. When the rear housing 240 is combined with the portable terminal body 220, a portion of the lower portion of the antenna sheet 120 and a portion of the upper portion of the radiation sheet 140 overlap each other, thereby forming an overlap area 300. The first radiation pattern 122 and the radiation sheet 140 form a radiation field by magnetic-coupling in the overlap area 300.

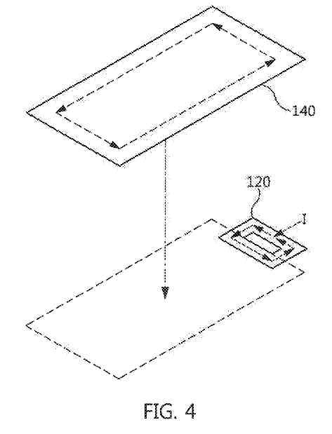

As shown in FIG. 4, when a current I is applied to the first radiation pattern 122, magnetic flux is generated by a counterclockwise current in the first radiation pattern 122. The magnetic flux generated in the first radiation pattern 122 is intended to link to the radiation sheet 140, so an induced current is generated in the opposite direction to the current flowing in the first radiation pattern 122, at a portion of the upper portion of the radiation sheet 140 overlapping the first radiation pattern 122 (that is, a counterclockwise induced current is generated). Accordingly, the induced current generated at a portion of the upper portion circulates around the edge of the radiation sheet 140.

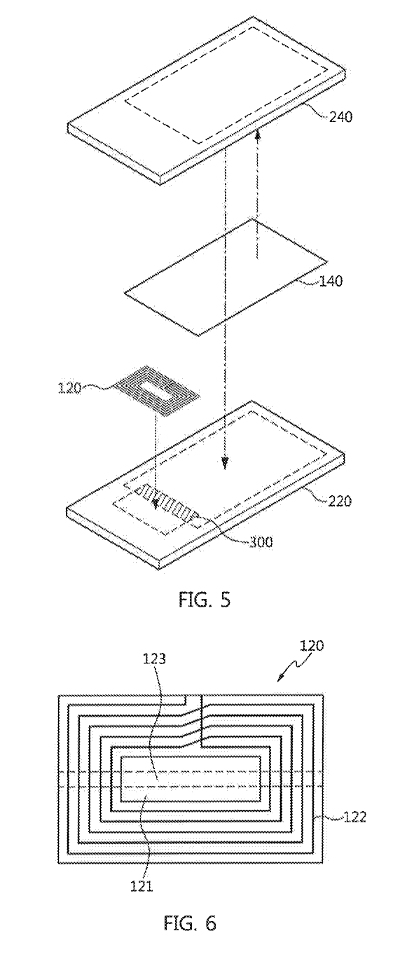

As shown in FIG. 5, the antenna sheet 120 may be disposed at the lower portion on the rear side of the portable terminal body 220 and the radiation sheet 140 may be disposed in a rear housing 240. When the rear housing 240 is combined with the portable terminal body 220, a portion of the upper portion of the antenna sheet 120 and a portion of the lower portion of the radiation sheet 140 overlap each other, thereby forming an overlap area 300.

As described above, in the wireless communication antenna module, the first radiation pattern 122 of the antenna sheet 120 and the radiation sheet 140 partially overlap each other, thereby forming the overlap area 300, so the radiation area of a magnetic field increases and magnetic flux loop is increased by the radiation sheet 140.

Hereafter, a wireless communication antenna module according to a second embodiment of the present invention is described in detail with reference to the accompanying drawings. FIGS. 6 to 17 are diagrams illustrating a wireless communication antenna module according to the second embodiment of the present invention. The wireless communication antenna module according to the embodiment of the present invention can be applied to near field communication such as Bluetooth and a wireless communication antenna module applied to an NFC band is exemplified.

The wireless communication antenna module includes an antenna sheet 120 mounted on a portable terminal body 220 (or a battery pack) and a radiation sheet 140 disposed in a rear housing 240 of a portable terminal and forming an overlap area 300 by partially overlapping the antenna sheet 120 when the portable terminal body 220 and the rear housing 240 are combined.

The antenna sheet 120 has a first radiation pattern 122 on at least one of the top and the bottom. The first radiation pattern 122 of the antenna sheet 120 is formed by winding a wire several times in a loop shape around the edge of a non-patterned portion.

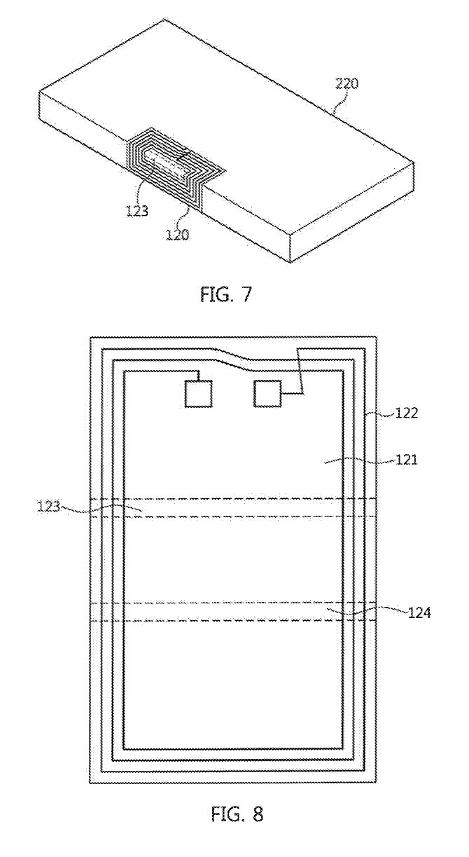

The antenna sheet 120 has one bending portion. That is, as shown in FIG. 6, the antenna sheet 120 has a first bending portion 123 and one side is bent with respect to the first bending portion 123 and mounted on a side and the rear side of the portable terminal body 220. For example, referring to FIG. 7, one side of the antenna sheet 120 is bent to the right in a “□” shape with respect to the first bending portion 123. A “−” area of the antenna sheet 120 is mounted on the rear side of the portable terminal body 220 and a “|” area is mounted on a side of the portable terminal body 220. Further, one side of the antenna sheet 120 may be bent to the left in a “┐” shape with respect to the first bending portion 123. The shape of the antenna sheet 120 may be implemented in various ways in accordance with the position of the antenna sheet 120 mounted on a portable terminal.

As shown in FIG. 8, the antenna sheet 120 may include a non-first patterned portion 121, a first radiation pattern 122, a first bending portion 123, and a second bending portion 124. A first side of the antenna sheet 120 is bent with respect to the first bending portion 123 and a second side is bent with respect to the second bending portion 124 and mounted on the front side, the rear side, and a side of the portable terminal body 220. The fast radiation pattern 122 is formed in the shape of a loop in which a wire is wound several times around the non-first patterned portion 121.

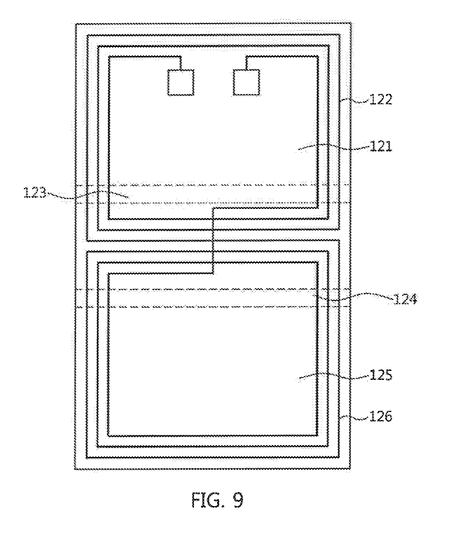

As shown in FIG. 9, the antenna sheet 120 includes a non-first patterned portion 121, a first radiation pattern 122, a first bending portion 123, a second bending portion 124, a non-second patterned portion 125, and a second radiation pattern 126. The first radiation pattern 122 is formed in the shape of a loop in which a wire is wound several times around the non-first patterned portion 121. The second radiation pattern 126 is formed in the shape of a loop in which a wire is wound several times around the non-second patterned portion 125. A first end of the first radiation pattern 122 is connected to a power supply terminal and a second end is connected to a first end of the second radiation pattern 126. A second end of the second radiation pattern 126 is connected to another power supply terminal. Accordingly, the first radiation pattern 1222 is formed in a “ [symbol] ” shape on the antenna sheet 120.

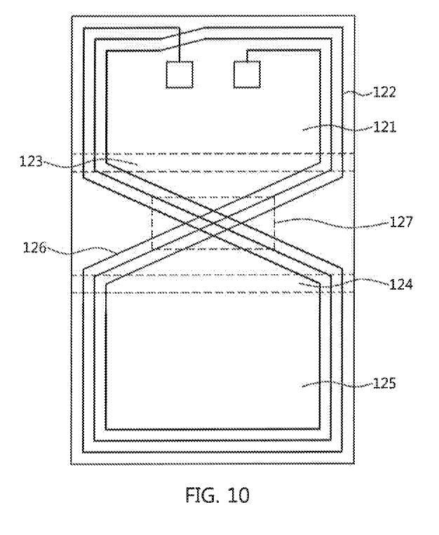

As shown in FIG. 10, the antenna sheet 120 includes a non-first patterned portion 121, a first radiation pattern 122, a first bending portion 123, a second bending portion 124, and a non-second patterned portion 125. The second radiation pattern 122 is formed in the shape of a loop in which a wire is wound several times around the non-first patterned portion 121 and the non-second patterned portion 125. The first radiation pattern 122 is formed in an “8” shape by forming a cross area 127 formed in an X-shape between the first bending portion 123 and the second bending portion 124. Both ends of the first radiation pattern 122 are connected to different power supply terminals.

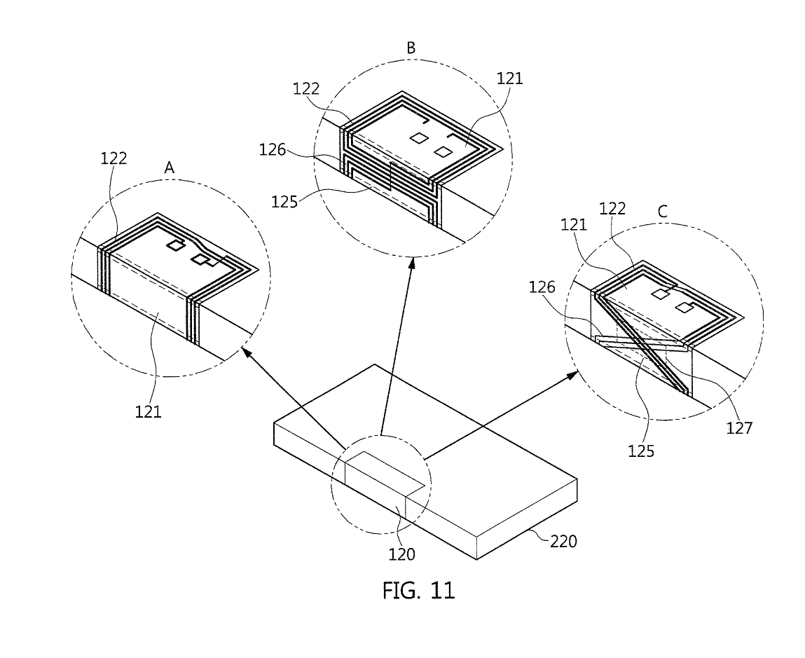

As shown in FIG. 11, a first side of the antenna sheet 120 is bent to the right with respect to the first bending portion 123 and a second side is bent to the right with respect to the second bending portion 124, so the antenna sheet 120 is formed in a “⊂” shape. Accordingly, the portion from the first side to the first bending portion 123 of the antenna sheet 120 is mounted on the rear side of the portable terminal body 220. The portion from the first bending portion 123 to the second bending portion 124 of the antenna sheet 120 is mounted on a side of the portable terminal body 220. The portion from the second bending portion 124 to the second side of the antenna sheet 120 is mounted on the front side of the portable terminal body 220.

FIG. 11A shows an example when the antenna sheet 120 shown in FIG. 8 is mounted on the portable terminal body 220, in which portions of the non-first patterned portion 121 and the first radiation patterns 122 at both sides of the non-first patterned portion 121 are disposed on a side of the portable terminal body 220.

FIG. 11B shows an example when the antenna sheet 125 shown in FIG. 9 is mounted on the portable terminal body 220, in which portions of the non-first patterned portion 121, the non-second patterned portion 125, the first radiation pattern 122, and the second radiation pattern 126 are disposed on a side of the portable terminal body 220.

FIG. 11C shows an example when the antenna sheet 125 shown in FIG. 10 is mounted on the portable terminal body 220, in which portions of the non-first patterned portion 121 and the non-second patterned portion 125, and the cross area 127 of the first radiation pattern 122 are disposed on a side of the portable terminal body 220.

Obviously, the first side of the antenna sheet 120 may be bent to the left with respect to the first bending portion 123 and the second side may be bent to the left with respect to the second bending portion 124, thereby forming a “⊃” shape. The shape of the antenna sheet 120 may be set in various ways in accordance with the position of the antenna sheet 120 mounted on a portable terminal.

The radiation sheet 140 is made of metal and disposed inside a rear housing 240 of a portable terminal to operate as a sub-radiator of the first radiation pattern 122 formed on the antenna sheet 120. The radiation sheet 140 may be formed in various shapes in accordance with the shape of the rear housing 240.

The radiation sheet 140 overlaps the antenna sheet 120 when the portable terminal body 220 and the rear housing 240 are combined. Accordingly, a portion of a first side of the radiation sheet 140 overlaps the first radiation pattern 122 on the antenna sheet 120, thereby forming the overlap area 300. The radiation sheet 140 operates as a sub-radiator by magnetic-coupling with the first radiation pattern 122 in the overlap area 300.

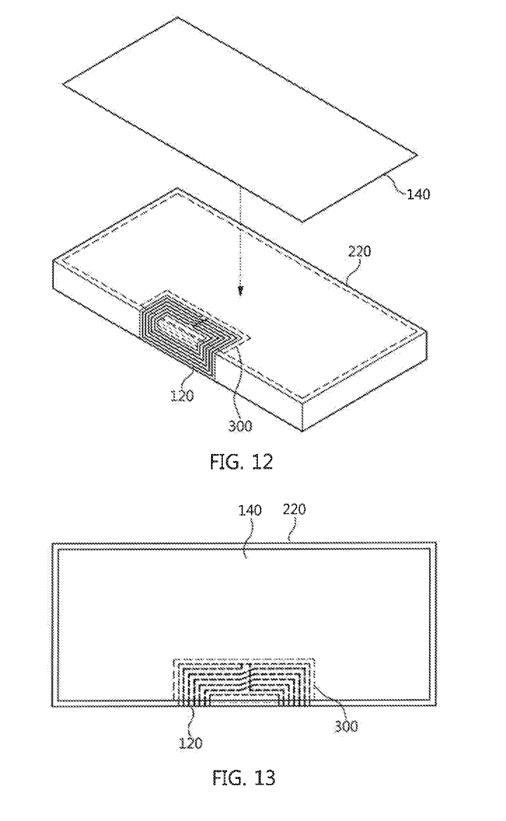

As shown in FIG. 12, the radiation sheet 140 overlaps a portion of the antenna sheet 120 mounted on the rear side of the portable terminal body 220. That is, the radiation sheet 140 forms the overlap area 300 with the first radiation pattern 122 except for the non-first patterned portion 121 on the rear side of the portable terminal body 220 and the first radiation patterns 122 at both sides of the non-first patterned portion 121. Accordingly, as shown in FIG. 13, the radiation sheet 140 forms the overlap area 300 with a portion of the first radiation pattern 122 on the rear side of the portable terminal body 220, with respect to the top of the antenna sheet 120 where the radiation sheet 140 is disposed, and does not overlap the non-first patterned portion 121 and the first radiation patterns 122 at both sides of the non-first patterned portion 121.

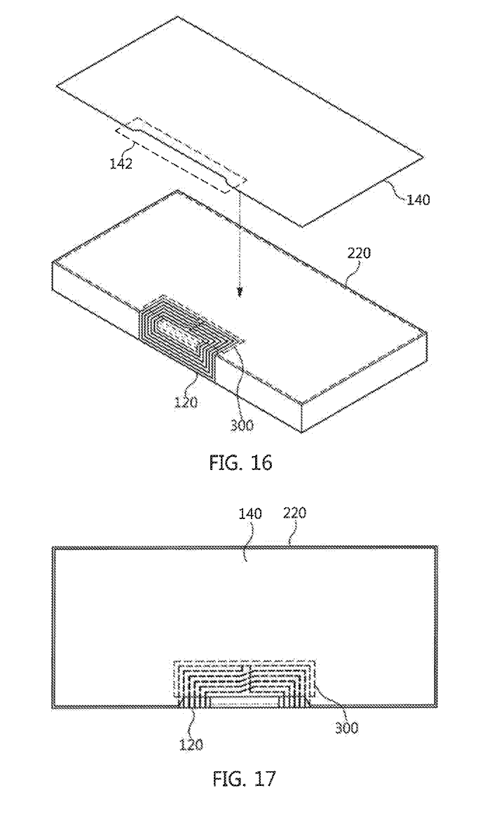

Further, as shown in FIG. 16, the radiation sheet 140 may overlap only a portion of the antenna sheet 120 mounted on the rear side of the portable terminal body 220 through an opening at a side. That is, the radiation sheet 140 forms an overlap area 300 with the first radiation pattern 122 except for the non-first patterned portion and the first radiation patterns 122 at both sides of the non-first patterned portion 121, of the non-first patterned portion 121 and the first radiation pattern 122 positioned at a side of the antenna sheet 120 mounted on the rear side of the portable terminal body 220, through an opening 142 formed at a side overlapping the antenna sheet 120. Accordingly, as shown in FIG. 17, the radiation sheet 140 forms the overlap area 300 with the non-first patterned portion 121 disposed on the rear side of the portable terminal body 220 and a portion of the first radiation pattern 122 on the rear side of the portable terminal body 220, with respect to the top of the antenna sheet 120 where the radiation sheet 140 is disposed, and does not overlap the first radiation patterns 122 at both sides of the non-first patterned portion 121.

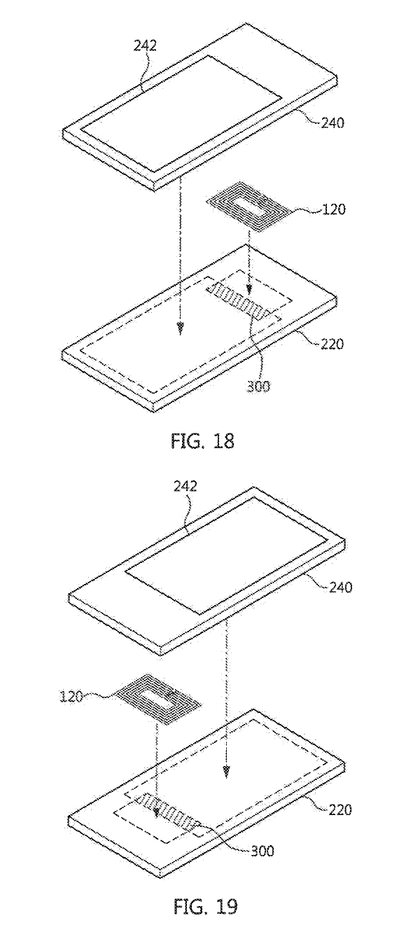

Hereafter, a wireless communication antenna module according to a third embodiment of the present invention is described in detail with reference to the accompanying drawings. FIGS. 18 to 22 are diagrams illustrating a wireless communication antenna module according to the third embodiment of the present invention. The wireless communication antenna module according to the embodiment of the present invention can be applied to near field communication such as Bluetooth and a wireless communication antenna module applied to an NFC band is exemplified.

As shown in FIG. 18, the wireless communication antenna module includes an antenna sheet 120 mounted on a portable terminal body 220 or a battery pack and a rear housing 240 coupled to the rear side of a portable terminal. The antenna sheet 120 is the same as the antenna sheets 120 of the first and second embodiments, so the detailed description is not provided.

The rear housing 240 is made of metal to operate as a sub-radiator of the first radiation pattern 122 formed on the antenna sheet 120. As shown in FIG. 18, the rear housing 240 is made of metal at a portion of the side facing the rear side of the portable terminal body 220, thereby forming a metal area 242, and the other area (that is, a portion of the rear side and four sides connected to the rear side) is made of resin. Obviously, the rear housing 240 may be made of metal throughout the side facing the rear side of the portable terminal body 220, thereby forming a metal area 242.

The metal area 242 of the rear housing 240 overlaps the antenna sheet 120 when it is combined with the portable terminal body 220. Accordingly, the radiation sheet 140 forms an overlap area 300 by partially overlapping at a side the first radiation pattern 122 formed on the antenna sheet 120 and operates as a sub-radiator in the overlap area 300 by magnetic-coupling with the first radiation pattern 122.

The coupling relationship between the antenna sheet 120 and the rear housing 240 is described hereafter, with reference to FIGS. 18 and 19.

As shown in FIG. 18, the antenna sheet 120 is disposed at the upper portion on the rear side of the portable terminal body 220 and a metal area 242 is formed at a portion of the rear housing 240. When the rear housing 240 is combined with the portable terminal body 220, a portion of the lower portion of the antenna sheet 120 and a portion of the upper portion of the metal area 242 overlap each other, thereby forming the overlap area 300. The metal area 242 of the rear housing 240 generates a radiation field by magnetic-coupling with the first radiation pattern 122 in the overlap area 300. When a current is applied to the first radiation pattern 122, magnetic flux is generated in the first radiation pattern 122 by a clockwise current. The magnetic flux generated in the first radiation pattern 122 is intended to link to the metal area 242 of the rear housing 240, so an induced current is generated in the opposite direction to the current direction flowing in the first radiation pattern 122 in the overlap area 300 of the metal area 242 (that is, a counterclockwise induced current is generated). Accordingly, the induced current generated in the overlap area 300 circulates around the edge of the metal area 242 of the rear housing 240.

As shown in FIG. 19, the antenna sheet 120 may be disposed at the lower portion on the rear side of the portable terminal body 220. When the rear housing 240 is combined with the portable terminal body 220, a portion of the upper portion of the antenna sheet 120 and a portion of the lower portion of the metal area 242 of the rear housing 240 overlap each other, thereby forming an overlap area 300. The metal area 242 of the rear housing 240 generates a radiation field by magnetic-coupling with the first radiation patter 122 in the overlap area 300.

As described above, in the wireless communication antenna module, the first radiation pattern 122 of the antenna sheet 120 and the metal area 242 of the rear housing 240 partially overlap each other, thereby forming the overlap area 300, so the radiation area of a magnetic field increases and magnetic flux loop is increased by the metal area 242 of the rear housing 240.

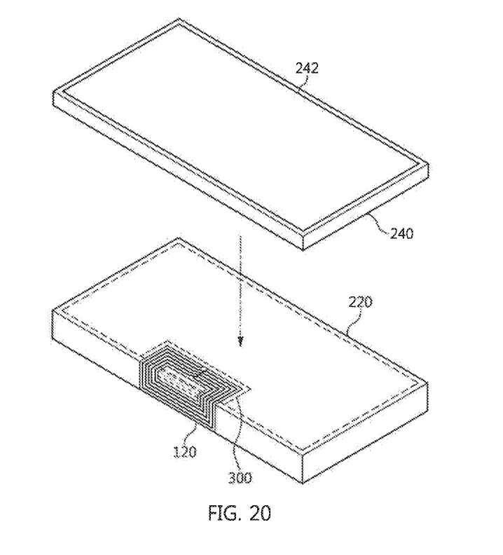

FIGS. 20 to 22 are diagrams illustrating the metal area 242 of the rear housing in the wireless communication antenna module including the antenna sheet 120 (see FIG. 6 and FIGS. 8 to 20) having one ore more bending portions.

As shown in FIG. 20, the rear housing 240 has the metal area 242 forming the overlap area 300 by overlapping a portion of the antenna sheet 120 mounted on the rear side of the portable terminal body 220. That is, the radiation sheet 240 has the metal area 242 that forms the overlap area 300 by overlapping non-first pattered portion 121 and the first radiation pattern 122 except for the first radiation patterns 122 at both sides of the non-first patterned portion 121 on the rear side of the portable terminal body 220. Accordingly, the metal area 242 forms the overlap area 300 with a portion of the first radiation pattern 122 on the rear side of the portable terminal body 220, with respect to the top of the antenna sheet 120 where the rear housing 240 is disposed, and does not overlap the non-first patterned portion 121 and the first radiation patterns 122 at both sides of the non-first patterned portion 121.

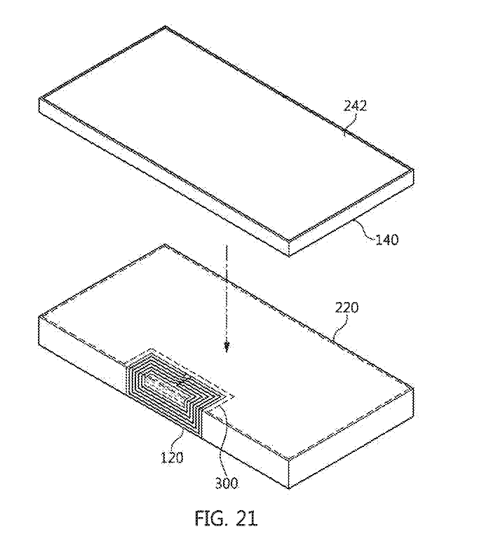

Further, as shown in FIG. 21, the rear housing 240 may have a metal area 242 overlapping the entire antenna sheet 120 mounted on the rear side of the portable terminal body 220. That is, the rear housing 240 has the metal area 242 that forms the overlap area 300 by overlapping the non-first patterned portion 121 and the first radiation pattern 122 on a side of the antenna sheet 120 mounted on the rear side of the portable terminal body 220. Accordingly, the metal area 242 of the rear housing 240 forms the overlap area 300 by overlapping the non-first patterned portion 121 and the first radiation pattern 122 disposed on the rear side of the portable terminal body 220, with respect to the top of the antenna sheet 120 where the rear housing 240 is disposed.

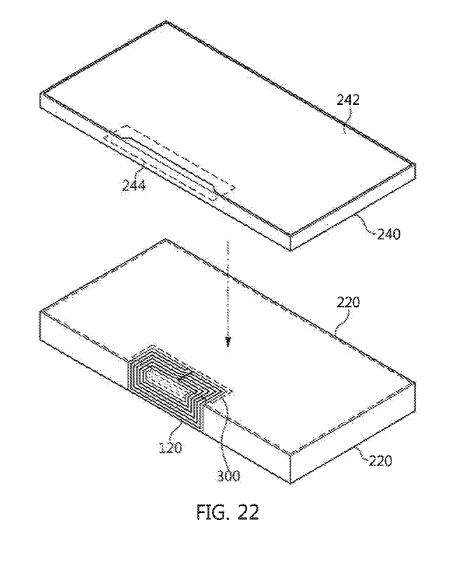

Further, as shown in FIG. 22, the rear housing 240 may have a metal area 242 that forms an overlap area 300 by overlapping a portion of the antenna sheet 120 mounted on the rear side of the portable terminal body 220 through an opening 244 at a side. That is, the radiation sheet 240 has the metal area 242 that forms the overlap area 300 by overlapping non-first patterned portion 121 and the first radiation pattern 122 except for the first radiation patterns 122 at both sides of the non-first patterned portion 121 on the rear side of the portable terminal body 220. Accordingly, the metal area 242 forms the overlap area 300 with a portion of the first radiation pattern 122 on the rear side of the portable terminal body 220, with respect to the top of the antenna sheet 120 where the rear housing 240 is disposed, and does not overlap the non-first patterned portion 121 and the first radiation patterns 122 at both sides of the non-first patterned portion 121.

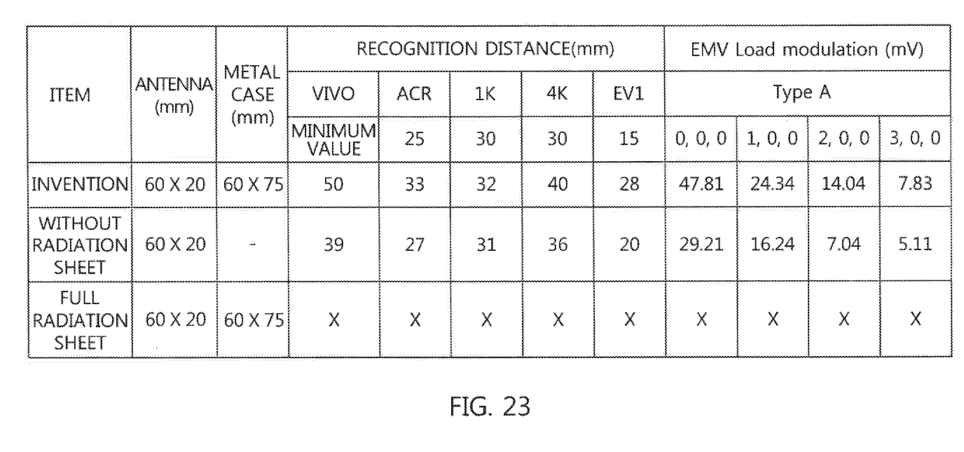

Hereafter, antenna characteristics of a wireless communication antenna module according to an embodiment of the present invention are described in detail with reference to the accompanying drawings. FIGS. 23 to 31 are diagrams illustrating antenna characteristics of a wireless communication antenna module according to an embodiment of the present invention.

FIG. 23 shows antenna characteristics of a wireless communication antenna module of the present invention, a wireless communication antenna module without a radiation sheet of the related art, and a wireless communication antenna module with a radiation sheet fully covering an antenna sheet. From the figure, it can be seen that the wireless communication antenna module of the present invention has improved antenna performance because a recognition distance and an EMV Load modulation characteristic in a reader mode are increased, as compared with the wireless communication antenna module of the related art and the wireless communication antenna module with a radiation sheet fully covering an antenna sheet.

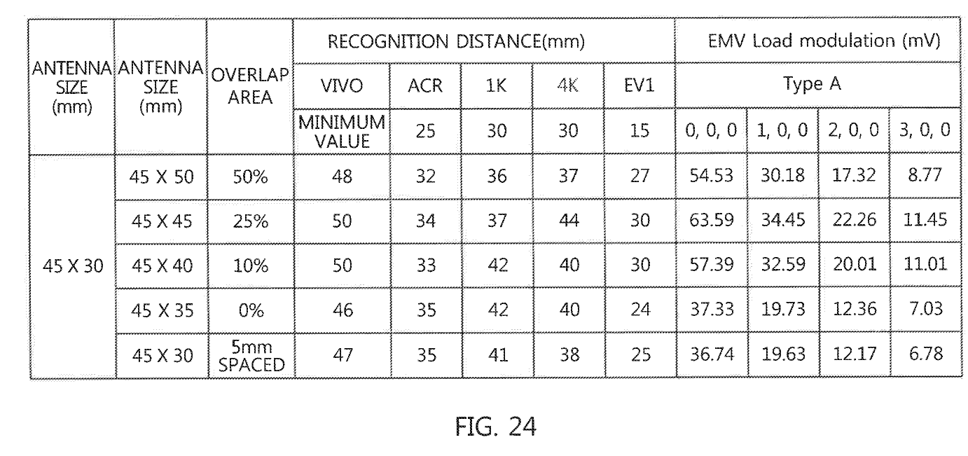

FIG. 24 shows antenna characteristics measured by changing the overlap area 300 between the radiation sheet 140 and the antenna sheet 120 in the wireless communication antenna module of the present invention. From this figure, it can be seen that when the overlap area 300 of the radiation sheet 140 and the antenna sheet 120 (that is, the first radiation pattern 122) is 10 to 25% (that is, the radiation sheet 140 is overlapped as large as the width of the first radiation pattern 122), the recognition distance and the EMV Load modulation characteristic in a reader mode are increased, so the antenna performance is improved.

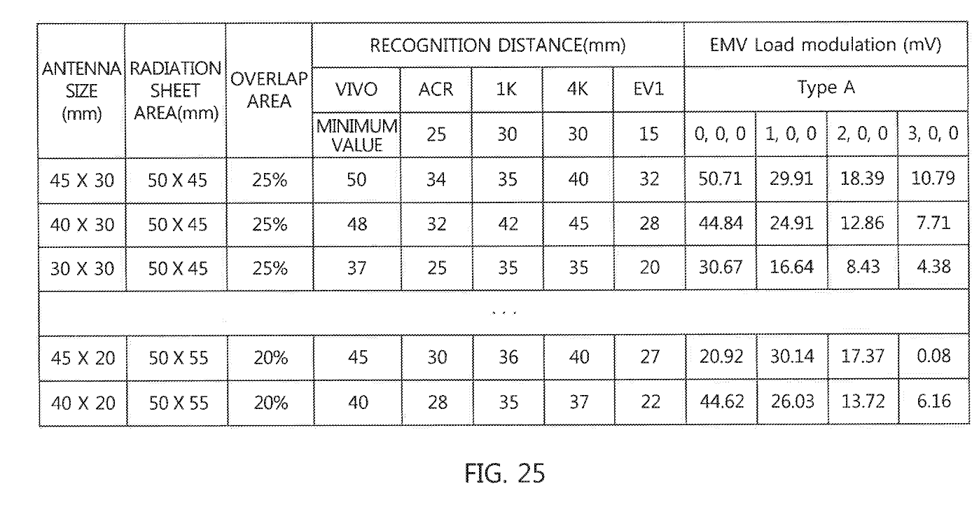

FIG. 25 shows antenna characteristics measured by changing the size of the antenna sheet 120 in the wireless communication antenna module of the present invention. From this figure, it can be seen that when the antenna sheet 120 (or the first radiation pattern 122) is formed in a cube or a rectangle in accordance with the environment (or structure) of a portable terminal, and when it is a rectangle, the recognition distance and the EMV Load modulation in a reader mode are increased and the antenna performance is improved, as compared with a wireless communication antenna module having the same area of the related art. Further, it is possible to simplify the manufacturing process of an antenna by minimizing the removal area of the radiation sheet 140.

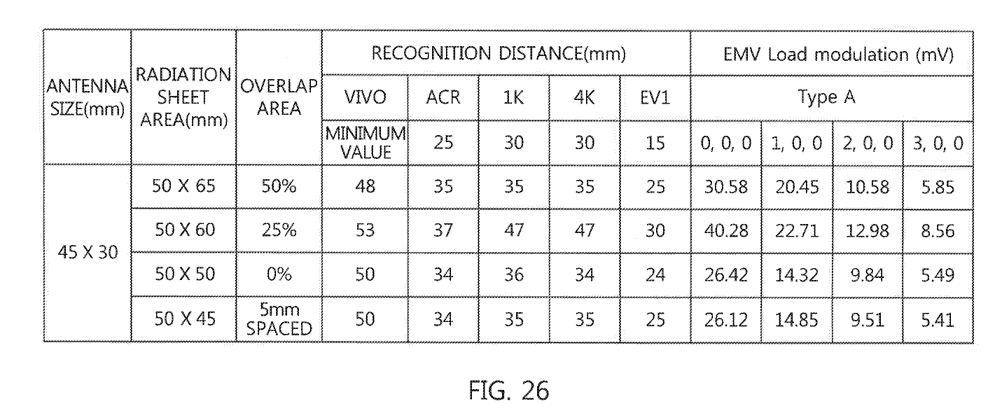

FIG. 26 shows antenna characteristics measured by changing the mounting position of the antenna sheet 120 in the wireless communication antenna module of the present invention. From this figure, it can be seen that the structure of mounting the antenna sheet 120 at an upper portion and the structure of mounting the antenna sheet 120 at a lower portion show similar antenna characteristics, and when the overlap area 300 is about 25% (that is, the radiation sheet 140 is overlapped as large as the width of the first radiation sheet 122), the antenna performance is improved.

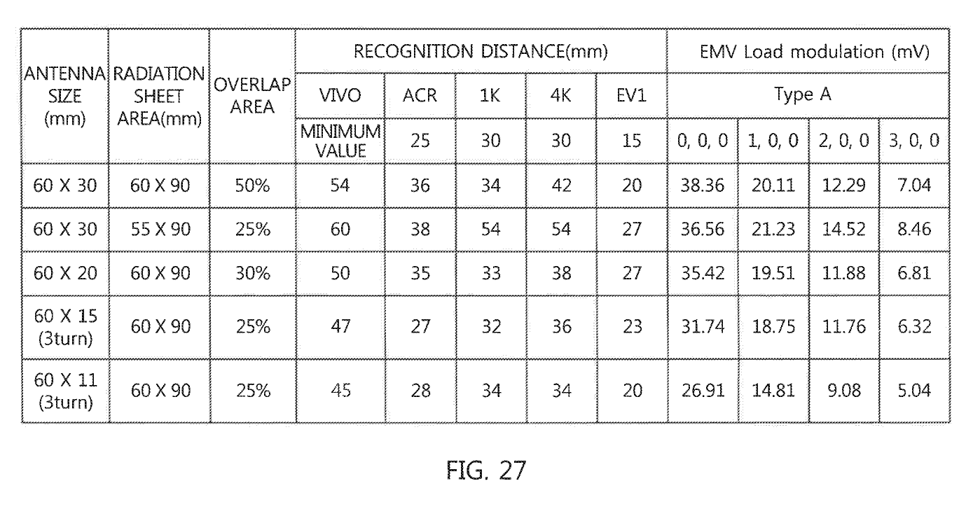

FIG. 27 shows antenna characteristics measured in a wireless communication antenna module including the antenna sheet 120 having one bending portion. From this figure, it can be seen the antenna performance of the antenna sheet 120 that is narrow and long is relatively excellent, and when it is applied to a thin portable terminal and attachment ability such as curving (bending) is considered, the antenna performance is improved.

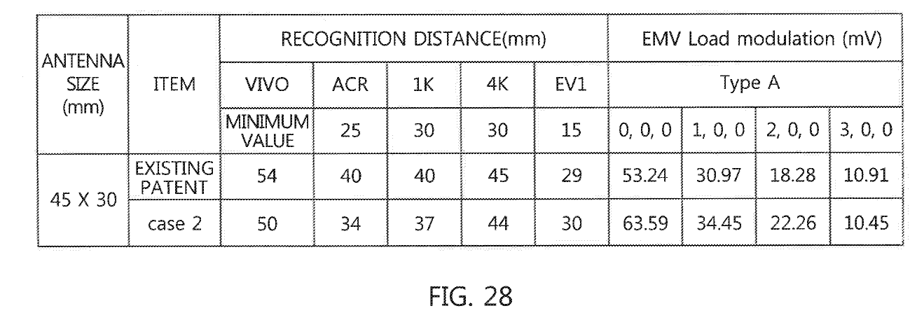

FIG. 28 shows antenna characteristics of a wireless communication antenna module of the present invention measured when a rectangular radiation sheet 140 without an opening (that is, slot or slit) is disposed to partially overlap the antenna sheet 120 (that is, the first radiation pattern 122). From this figure, it can be seen that the antenna performance is improved in the wireless communication antenna module of the present invention, in which the rectangular radiation sheet 140 without an opening (that is, slot or slit) is disposed to partially overlap the antenna sheet 120 (that is, the first radiation pattern 122), as compared with the related art. It can be seen that the antenna characteristics are the most excellent, when the overlap area 300 of the radiation sheet 140 and the antenna sheet 120 is as large as the width of the first pattern 122.

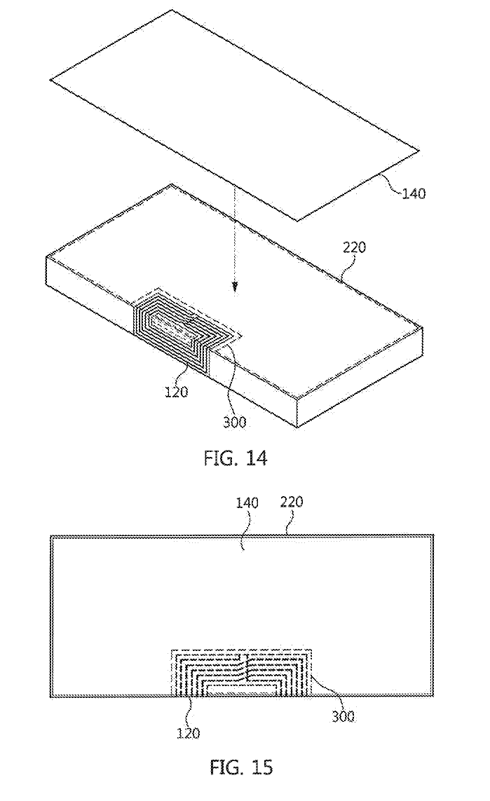

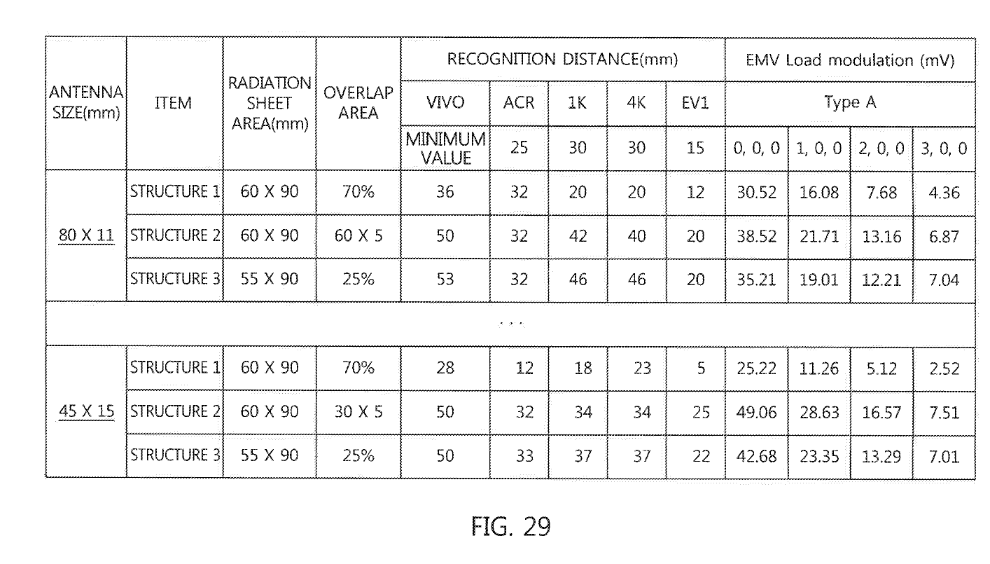

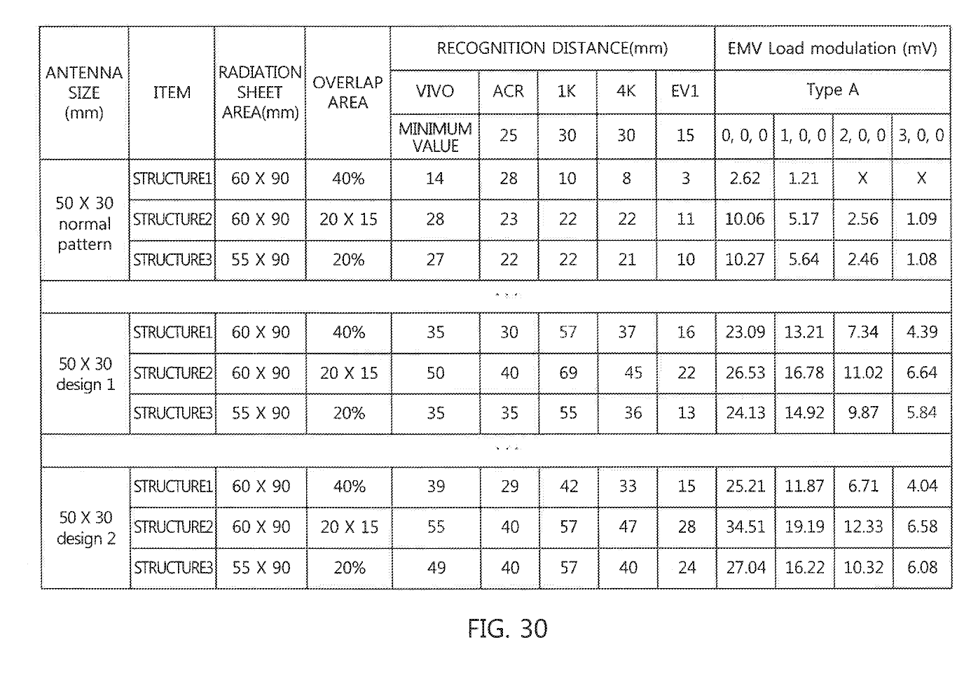

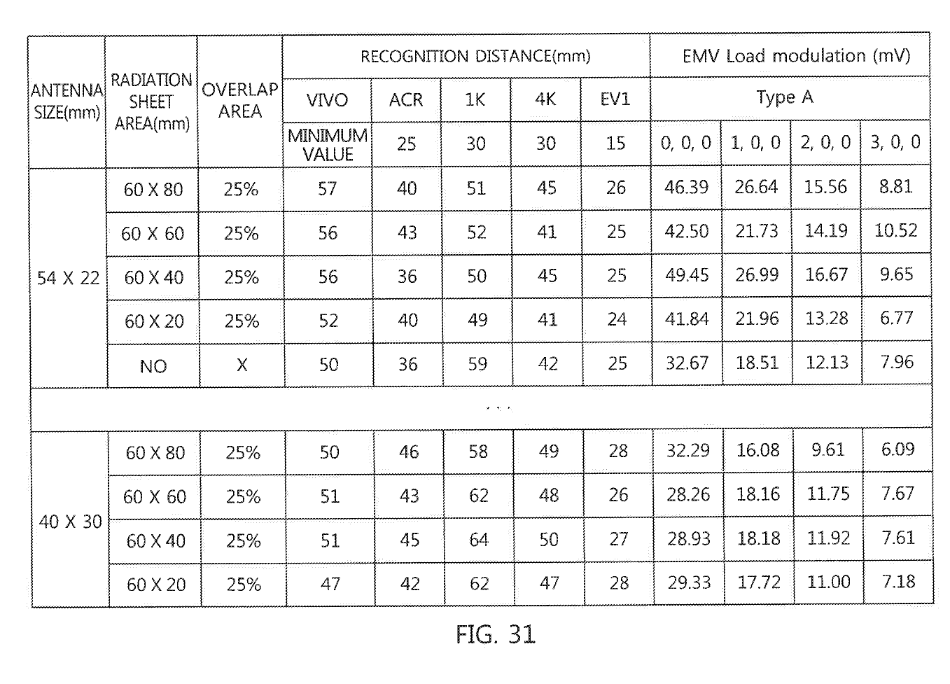

FIG. 29 shows antenna characteristics of a wireless communication antenna module of the present invention implemented in Structures 1 to 3 and FIG. 30 shows antenna characteristics of a wireless communication antenna module of the present invention including an antenna sheet 120 having two bending portions. ‘Normal pattern’ is the structure of the first radiation pattern 122 shown in FIG. 8, ‘design1’ is the structure of the first radiation pattern 122 shown in FIG. 9, and ‘design2’ is the structure of the first radiation pattern 122 shown in FIG. 10. The Structure 1 (see FIGS. 16 and 22) is a structure in which a full radiation sheet 140 is provided and the overlap area 300 is about 60 to 70%, the Structure 2 (see FIGS. 14 and 21) is a structure in which a radiation sheet 140 having an opening (that is, slot or slit) is provided, and the Structure 3 (see FIGS. 12 and 20) is a structure in which the overlap area 300 is about 25% by reducing the size of the radiation sheet 140.

Accordingly, it can be seen that the antenna performance is improved in all the structures in comparison to wireless communication antenna modules of the related art, and the antenna performance is the most excellent in the structure in which the overlap area 300 is about 25%.

FIG. 31 shows antenna characteristics measured by changing the sizes of the antenna sheet 120 and the radiation sheet 140 in the wireless communication antenna module of the present invention. From this figure, it can be seen that the antenna performance is the most excellent when the overlap area 300 is about 25% (that is, overlapped as large as the width of the first radiation pattern 122) regardless of the sizes of the antenna sheet 120 and the radiation sheet 140.

As described above, since an overlap area is formed by overlapping a radiation pattern and a radiation sheet formed on an antenna sheet (or a rear housing of a portable terminal made of metal) in a wireless communication antenna module, the radiation area of a magnetic field is increased and the antenna characteristics are improved.

Further, since an overlap area is formed by overlapping a radiation pattern and a radiation sheet formed on an antenna sheet (or a rear housing of a portable terminal made of metal) in a wireless communication antenna module, a magnetic flux loop is increased by the radiation sheet (or the rear housing) and the antenna characteristics are improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wireless communication antenna module, comprising:
an antenna sheet having a radiation pattern thereon and mounted on a portable terminal body or a battery pack; and
a radiation sheet mounted on a rear housing of a portable terminal,
wherein when the portable terminal body and the rear housing are combined, the antenna sheet and the radiation sheet form an overlap area by overlapping each other.

2. The wireless communication antenna module of claim 1, wherein the antenna sheet has at least one bending portion and is mounted on at least one surface of a front side, a rear side, and a side of the portable terminal or the battery pack by bending with respect to the at least one bending portion.

3. The wireless communication antenna module of claim 2, wherein the radiation sheet forms an overlap area with a radiation pattern and a non-patterned portion formed on the antenna sheet mounted on the rear side of the portable terminal body or the battery pack.

4. The wireless communication antenna module of claim 3, wherein the radiation sheet has an opening at a side where the overlap area is formed.

5. The wireless communication antenna module of claim 2, wherein the radiation sheet forms an overlap area with a radiation pattern, except for radiation patterns formed on both sides of a non-patterned portion, in the radiation pattern formed on the antenna sheet mounted on the rear side of the portable terminal body or the battery pack.

6. The wireless communication antenna module of claim 1, wherein the antenna sheet includes:
a first radiation pattern formed in a loop shape by winding a wire several times around an edge of a non-first patterned portion; and
a second radiation pattern formed in a loop shape by winding a wire several times around an edge of a non-second patterned portion, and
a first end of the first radiation pattern is connected with a first end of the second radiation pattern.

7. The wireless communication antenna module of claim 1, wherein the antenna sheet includes a radiation pattern formed in a loop shape winding a wire several times around edges of a non-first patterned portion and a non-second patterned portion, and
the radiation pattern forms a cross area at an area mounted on a side of the portable terminal body or the battery pack.

8. A wireless communication antenna module, comprising:
an antenna sheet having a radiation pattern thereon and mounted on a portable terminal body or a battery pack; and
a rear housing having a metal area thereon and combined with the portable terminal body,
wherein when the portable terminal body and the rear housing are combined, the antenna sheet and the metal area of the rear housing form an overlap area by overlapping each other.

9. The wireless communication antenna module of claim 8, wherein the antenna sheet has at least one bending portion and is mounted on at least one surface of a front side, a rear side, and a side of the portable terminal or the battery pack by bending with respect to the at least one bending portion.

10. The wireless communication antenna module of claim 9, wherein the metal area of the rear housing forms an overlap area with a radiation pattern and a non-patterned portion formed on the antenna sheet mounted on the rear side of the portable terminal body or the battery pack.

11. The wireless communication antenna module of claim 10, wherein the metal area of the rear housing has an opening at a side where the overlap area is formed.

12. The wireless communication antenna module of claim 9, wherein the metal area of the rear housing forms an overlap area with a radiation pattern, except for radiation patterns formed on both sides of a non-patterned portion, in the radiation pattern formed on the antenna sheet mounted on the rear side of the portable terminal body or the battery pack.

13. The wireless communication antenna module of claim 8, wherein the antenna sheet includes:
a first radiation pattern formed in a loop shape by winding a wire several times around an edge of a non-first patterned portion; and
a second radiation pattern formed in a loop shape by winding a wire several times around an edge of a non-second patterned portion, and
a first end of the first radiation pattern is connected with a first end of the second radiation pattern.

14. The wireless communication antenna module of claim 8, wherein the antenna sheet includes a radiation pattern formed in a loop shape winding a wire several times around edges of a non-first patterned portion and a non-second patterned portion, and
the radiation pattern forms a cross area at an area mounted on a side of the portable terminal body or the battery pack.

15. A portable terminal including the wireless communication antenna module according to claim 1.
